(19) United States
(12) Patent Application Publication
(10) Pub. No.: US 2006/0244230 A1
(43) Pub. Date: Nov. 2, 2006

(54) Skateboard with rollers

(76) Inventors: Dwayne Glowner, Lakeland, FL (US); Cody Glowner, Lakeland, FL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/343,837

(22) Filed: Jan. 31, 2006

Related U.S. Application Data
(60) Provisional application No. 60/648,475, filed on Jan. 31, 2005.

(51) Int. Cl. B62M 1/00

(52) U.S. Cl. 280/87.042

(57) ABSTRACT

A skateboard with rollers has been developed. The skateboard includes a deck with two cylindrical shaped rollers that are mounted on the bottom of the deck. Each roller has an axle that can be shared with two wheels that can be removed or added as desired.

### CROSS-REFERENCE TO RELATED APPLICATIONS

This application claims priority from U.S. Provisional Patent Application 60/648,475 entitled “Skateboard with Rollers” that was filed on Jan. 31, 2005.

### BACKGROUND OF INVENTION

1. Field of the Invention

The invention relates generally to recreational equipment. More specifically, the present invention relates to a modified skateboard with rollers in addition to wheels.

2. Background Art

In recent years, skateboarding has dramatically increased in popularity. Additionally, many skateboarders perform complicated and difficult acrobatic tricks on their boards. However, attempting to learn these tricks are difficult and potentially dangerous for a novice. Consequently, a modified skateboard is needed that is easier for a novice to learn to ride.

### SUMMARY OF INVENTION

In some aspects, the invention relates to a skateboard, comprising: a deck; two cylindrical shaped main rollers that are mounted on the bottom of the deck; an axle that supports each of the main rollers; and a plurality of removable wheels, where at least two wheels share the axle with each main roller.

Other aspects and advantages of the invention will be apparent from the following description and the appended claims.

### BRIEF DESCRIPTION OF DRAWINGS

It should be noted that identical features in different drawings are shown with the same reference numeral.

FIGS. 1a and 1b show bottom views of a skateboard with rollers in accordance with embodiments of the present invention.

FIGS. 2a and 2b show side views of the embodiment of the present invention shown in FIG. 1a.

FIGS. 3a and 3b shows side views of the embodiment of the present invention shown in FIG. 1b.

FIG. 4 shows a detailed depiction of the wheels used in some embodiments of the present invention.

FIG. 5 shows a detailed depiction of the of the springs used in some embodiments of the present invention.

### DETAILED DESCRIPTION

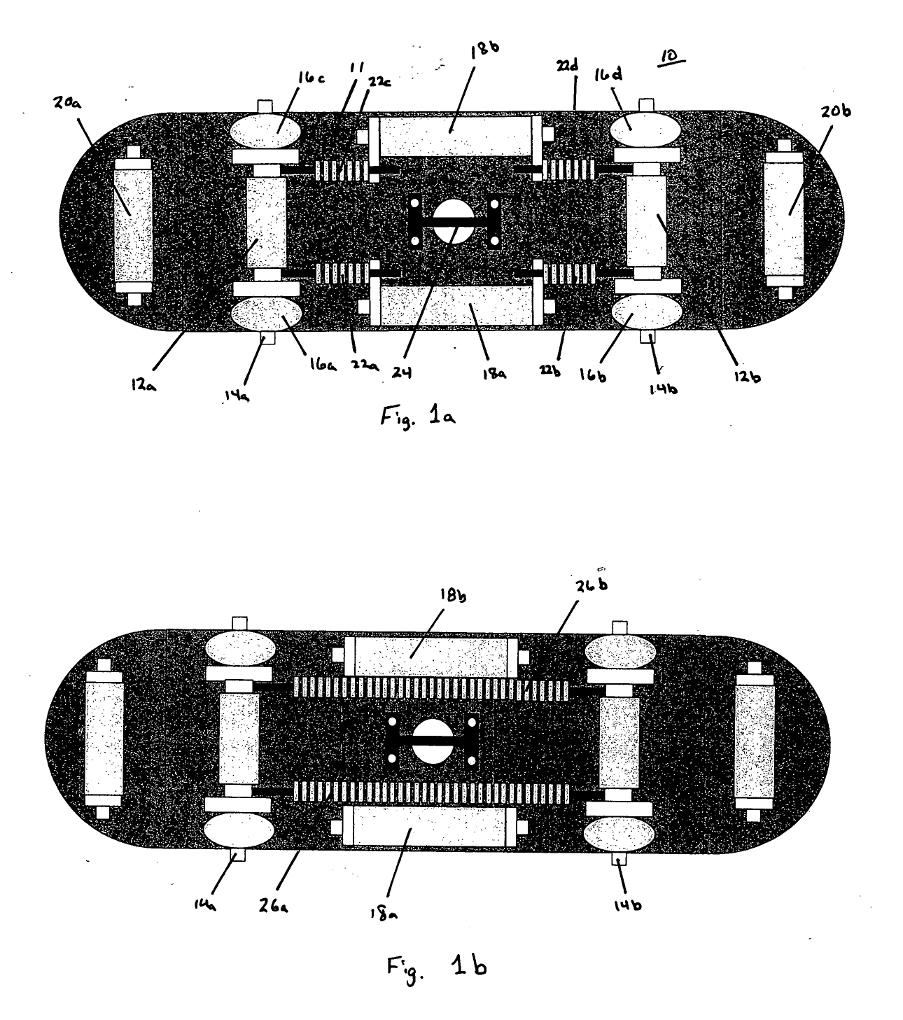

A modified skateboard with rollers in addition or in place of wheels has been developed. FIG. 1A shows a bottom view of a modified skateboard 10. A pair of main rollers 12a and 12b are mounted the bottom of the deck 11 of the skateboard 10 that allow for forward movement. The main rollers 12a and 12b are mounted on common axles 14a and 14b with four wheels 16a-16d. The wheels 16a-16d are removable from the axles 14a and 14b so that the skateboard may move with the use of the main rollers 12a and 12b alone. An advantage of the use of rollers, is the reduction of “wobbles” which can occur to skateboard wheels as they travel at high speeds.

Also attached are two lateral rollers 18a and 18b that allow the skateboard to move in a lateral direction when the rider is performing stunts such as “riding a rail”. The lateral rollers 18a and 18b have a higher centerline than the axles 14a and 14b that support the main rollers/wheels. This prevents the lateral rollers from dragging during forward movement of the skateboard.

A nose roller 20a and tail roller 20b are also attached on the respective ends of the skateboard 10. These rollers provide support for the skateboard when the rider is performing “wheelies” by pushing down on the rear and elevating the nose or “riding the nose” by pushing down on the nose and elevating the rear of the board. These rollers 20a and 20b allow for a novice to practice these stunts while maintaining a greater degree of control of the skateboard 10.

Four spring support assemblies 22a-22d attach the axles 14a and 14b to the brackets of the lateral rollers 18a and 18b. The assemblies 22a-22d serve to support the weight of the rider while also acting as shock absorbers for any impact of stunts such as jumps or hops. FIG. 1b shows an alternative embodiment of the present invention where a longer pair of spring support assemblies 26a and 26b are used to connect the axles 14a and 14b directly to each other bypassing the lateral rollers 18a and 18b.

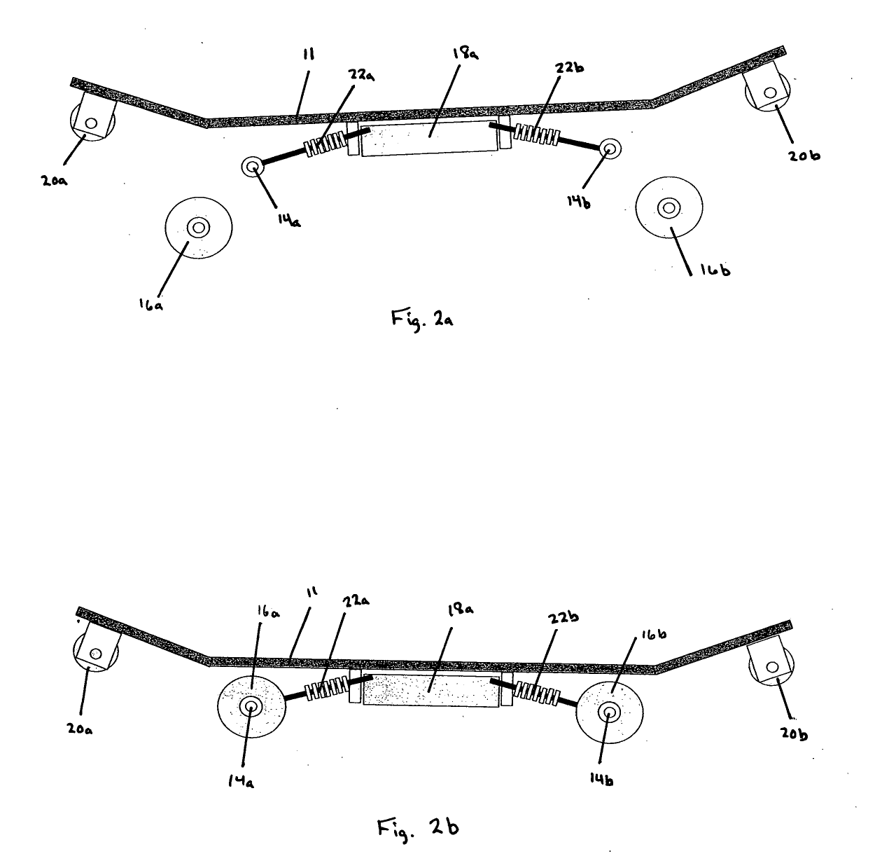

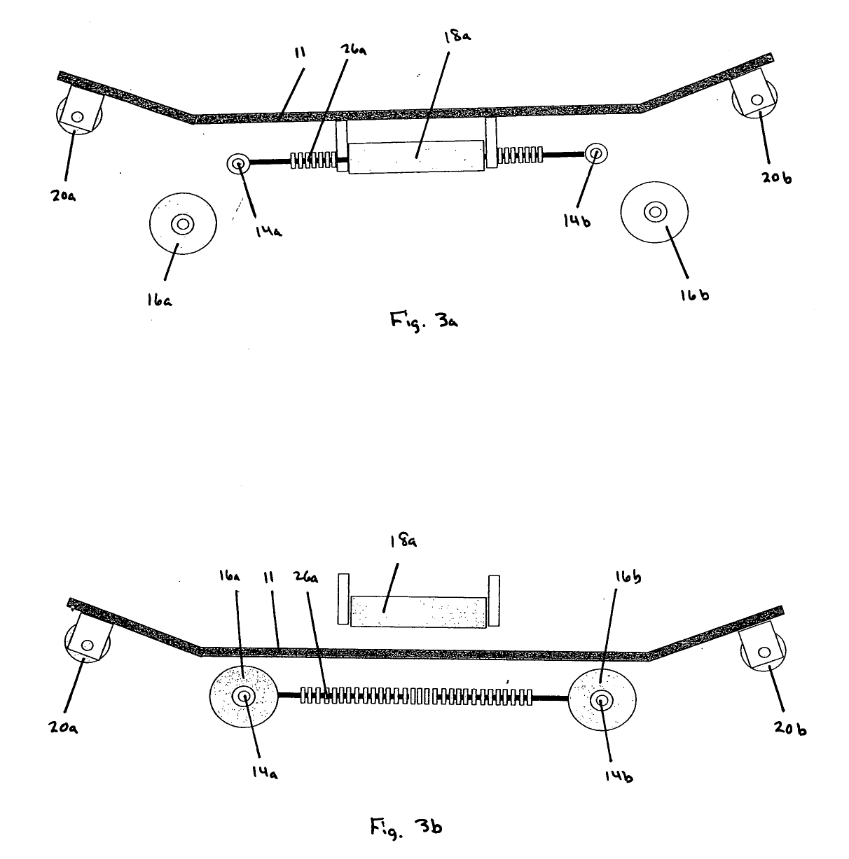

FIGS. 2a and 2b show side views of the embodiment of the present invention shown in FIG. 1a. In FIG. 2a, the skateboard 10 is shown with the wheels 16a-16d detached while FIG. 2b shows the skateboard 10 with the wheels16a-16d in place. FIGS. 3a and 3b show side views of the embodiment of the present invention shown in FIG. 1b. In FIG. 3a, the skateboard 10 is shown with the lateral rollers 18a detached while FIG. 3b shows the skateboard 10 with the lateral rollers 18a in place. Additionally, the nose and tail of the skateboard 10 that is tilted upward as shown in FIGS. 2a, 2b, 3a and 3b. This allows the nose roller 20a and tail roller 20b to avoid dragging the ground when the board is moving forward.

Also shown in FIGS. 1a and 1b is a strap bracket 24. The bracket 24 is mounted on the bottom of the skateboard 10 but is accessible through a hole in the deck. A strap (not shown) is attached to the bracket 24 and held by the rider. As the rider attempts to perform stunts such as jumps, hops, spins, etc., the rider will pull up on the strap in order to keep the skateboard against his feet. Additionally, the strap will also prevent the skateboard from getting away from the rider if he has to jump off the board.

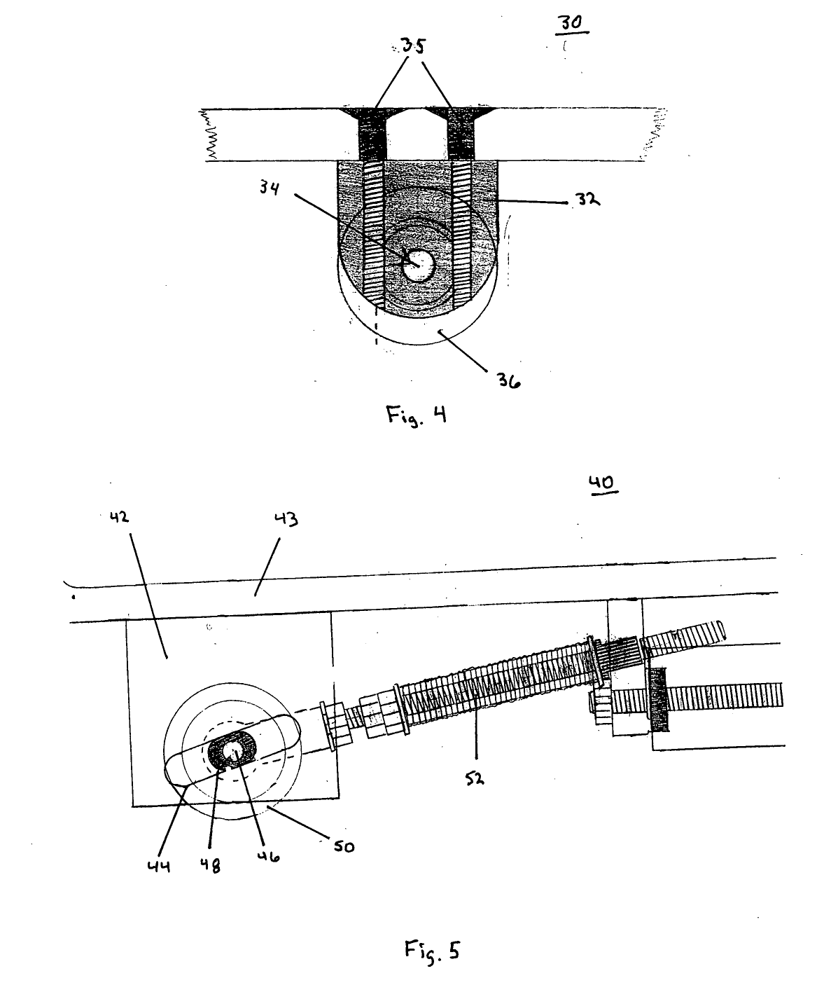

FIG. 4 shows a detailed side view of a mounting assembly for a roller in accordance with one embodiment of the present invention. This mounting assembly 30 is used for the lateral rollers as well as the nose and tail rollers described previously. The assembly includes a mounting bracket 32 that is attached to the deck of the board with screws 35. In this embodiment, the bracket is 1.5 inches wide. The bracket 32 has a center hole for the axle 34 that supports the roller 36.

FIG. 5 shows a detailed side view of the spring support assembly 40 used for the main rollers in accordance with one embodiment of the present invention. This mounting assembly 40 includes a mounting bracket 42 that is attached to the deck 43. The mounting bracket 42 has a slot 44 that is cut in the bracket along the axis of the spring 52. The axle 46 that supports the roller 50 is seated in a bushing 48 that moves within the slot 44. This mounting assembly 40 allows a rider to turn the skateboard when riding on the main rollers alone without the wheels.

When a rider on the skateboard wants to turn, he shifts his weight in the desired direction. This increases the force on one side of the board. As the force increases, the springs on that side will compress and pull that end of the axle further up into the slot. On the other side, the spring will expand and push the end of the axle down into the slot. The rear main roller assembly will perform in the same way. This will shift the orientation of the main rollers slightly and turn the skateboard in the direction of the weight shift of the rider. Once the turn is complete, the rider will re-center his weight and the rollers will return to a normal orientation.

It is important to note that the various features of the skateboard described previously are optional and that the present invention may be configured with many different combinations of these features. The advantages of various embodiments of the present invention include: the use of multiple rollers which offer greater board stability; the capability to replace the rollers with wheels when desired; and the use of a strap to keep the board from getting away from the rider while performing tricks.

While the invention has been described with respect to a limited number of embodiments, those skilled in the art, having benefit of this disclosure, will appreciate that other embodiments can be devised which do not depart from the scope of the invention as disclosed here.

What is claimed is:

1. A skateboard, comprising:
a deck;
two cylindrical shaped main rollers that are mounted on the bottom of the deck; and
an axle that supports each of the main rollers.

2. The skateboard of claim 1, further comprising:
a plurality of removable wheels, where at least two wheels share the axle with each main roller.

3. The skateboard of claim 1, further comprising:
a pair of cylindrical shaped lateral rollers mounted on the bottom of the deck, where the lateral rollers are mounted perpendicular to the main rollers.

4. The skateboard of claim 1, further comprising:
a cylindrical shaped tail roller that is mounted on the rear of the deck; and
a cylindrical shaped nose roller that is mounted on the front of the deck.

5. The skateboard of claim 1, further comprising:
a pair of spring support assemblies that are attached to each end of a main roller, where the spring support assemblies will shift the alignment of the axle of each main roller when a rider shifts the weight load on the skateboard so that the skateboard can turn in the direction of the shift in weight load.

6. The skateboard of claim 5, where the pair of spring support assemblies connect the corresponding ends of opposing main rollers.

7. The skateboard of claim 3, further comprising:
four spring support assemblies that are attached to each end of the two main rollers, where the spring support assemblies will shift the alignment of the axle of each main roller when a rider shifts the weight load on the skateboard so that the skateboard can turn in the direction of the shift in weight load.

8. The skateboard of claim 7, where the four spring support assemblies connect each end of the two main rollers to a corresponding mounting bracket for the lateral rollers.

9. The skateboard of claim 1, further comprising:
a bracket for a strap that is attached to the bottom of the deck; and
a strap that is attached to the bracket and fed through an opening in the deck so that a rider may hold the strap.
